(19) United States
(12) Patent Application Publication
(10) Pub. No.: US 2007/0172960 A1
(43) Pub. Date: Jul. 26, 2007

(54) Capillary column and method of making

(76) Inventors: Abdul Malik, Lutz, FL (US); Dongxin Wang, Tampa, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/499,258

(22) Filed: Aug. 3, 2006

Related U.S. Application Data
(63) Continuation of application No. 09/763,419, filed on Jul. 19, 2001, now abandoned.
(60) Provisional application No. 60/102,483, filed on Sep. 30, 1998.
(60) Provisional application No. 60/097,382, filed on Aug. 21, 1998.

(51) Int. Cl. G01N 30/02

(52) U.S. Cl. 436/161; 96/101; 73/23.39

(57) ABSTRACT

The present invention concerns a new and useful structure for forming a capillary tube, e.g. for gas chromatography, and methods for forming the capillary tube are described. The capillary tube comprises a tube structure, and a deactivated surface-bonded sol-gel coating on a surface of the tube structure to form a stationary phase coating on that surface of the tube structure. According to the present invention the deactivated stationary phase sol-gel coating enables separation of analytes while minimizing adsorption of analytes on the separation column structure.

### CROSS-REFERENCE TO RELATED APPLICATIONS

This application is a continuation of U.S. patent application Ser. No. 09/763,419, filed Jul. 19, 2001; which is a National Stage filing of International Application No. PCT/US99/19113, filed Aug. 20, 1999; which claims priority to U.S. Provisional Application No. 60/102,483, filed Sep. 30, 1998 and U.S. Provisional Application No. 60/097,382, filed Aug. 21, 1998.

### TECHNICAL FIELD

The present invention relates to a new and useful capillary column, e.g. for gas chromatography, and to a new and useful method of making such a capillary tube.

### INTRODUCTION

The introduction of an open tubular column by Golan¹ about three decades ago, has revolutionized the analytical capability of gas chromatography (GC). Capillary GC is now a matured separation technique that is widely used in various fields of science and industry.²⁻⁵ Contemporary technology for the preparation of open tubular columns, is however, time-consuming. It consists of three major, individually-executed steps:⁶ capillary surface deactivation,⁷ static coating,⁸ and stationary phase immobilization.⁹ Involvement of multiple steps in conventional column technology increases the fabrication time and is likely to result in greater column-to-column variation.

The column deactivation step is critically important for the GC separation of polar compounds that are prone to undergo adsorptive interactions, e.g. with the silanol groups on fused silica capillary inner walls. In conventional column technology, deactivation is usually carried out as a separate step, and involves chemical derivatization of the surface silanol groups. Various reagents have been used to chemically deactivate the surface silanol groups.¹⁰⁻¹³ Effectiveness of these deactivation procedures greatly depends on the chemical structure and composition of the fused silica surface to which they are applied.

Of special importance are the concentration and mode of distribution of surface silanol groups. Because the fused silica capillary drawing process involves the use of high temperatures (2000° C.), the silanol group concentration on the drawn capillary surface may initially be low due to the formation of siloxane bridges under high temperature drawing conditions. During subsequent storage and handling, some of these siloxane bridges may undergo hydrolysis due to reaction with environmental moisture. Thus, depending on the post-drawing history, even the same batch of fused silica capillary may have different concentrations of the silanol groups that may also vary by the modes of their distribution on the surface.

Moreover, different degrees of reaction and adsorption activities are shown by different types of surface silanol groups.¹⁴ As a result, fused silica capillaries from different batches (or even from the same batch but stored and/or handled under different conditions), may not produce identical surface characteristics after being subjected to the same deactivation treatments. This makes surface deactivation a difficult to reproduce procedure.

To overcome these difficulties, some researchers have used hydrothermal surface treatments to standardize silanol group concentrations and their distributions over the surface.¹⁵ However, this additional step makes the lengthy column making procedure even longer.

Static coating is another time-consuming step in conventional column technology. A typical 30-m long column may require as much as ten hours or more for static coating. The duration of this step may vary depending on the length and diameter of the capillary, and the volatility of the solvent used.

To coat a column by the static coating technique, the fused silica capillary is filled with a stationary phase solution prepared in a low-boiling solvent. One end of the capillary is sealed (using a high viscosity grease or by some other means¹⁶), and the other end is connected to a vacuum pump. Under these conditions, the solvent begins to evaporate from the capillary end connected to the vacuum pump, leaving behind the stationary phase that becomes deposited on the capillary inner walls as a thin film. Stationary phase film of desired thickness can be obtained by using a coating solution of appropriate concentration that can be easily calculated through simple equations.¹⁷

In static coating, two major drawbacks are encountered. First, the technique is excessively time consuming, and not very suitable for automation. Second, the physically coated stationary phase film shows a pronounced tendency to rearrangements that may ultimately result in droplet formation due to Rayleigh instability.¹⁸ Such a structural change in the coated films may serve as a cause for the deterioration or even complete loss of the column's separation capability.

To avoid these undesirable effects, static-coated stationary phase films need to be stabilized immediately after their coating. This is usually achieved by stationary phase immobilization through free radical cross-linking¹⁹ that leads to the formation of chemical bridges between coated polymeric molecules of the stationary phase. In such an approach, stability of the coated film is achieved not through chemical bonding of the stationary phase molecules to the capillary walls, but mainly through an increase of their molecular size (and consequently, through decrease of their solubility and vapor pressure).

Such an immobilization process has a number of drawbacks. First, polar stationary phases are difficult to immobilize by this technique.²⁰ Second, free radical cross-linking reactions are difficult to control to ensure the same degree of cross-linking in different columns with the same stationary phase. Third, cross-linking reactions may lead to significant changes in the polymer structure, and chromatographic properties of the resulting immobilized polymer may significantly differ from those of the originally taken stationary phase.⁹ All these drawbacks add up to make column preparation by conventional techniques a difficult-to-control and reproduce task.²¹

### SUMMARY OF THE PRESENT INVENTION

The present invention provides a new and useful capillary column and a rapid and simple method of making such a column.

One aspect of the present invention is a new and useful capillary column for use, e.g. in gas chromatography. The capillary column comprises a tube structure, and a deactivated surface-bonded sol-gel coating on a portion of the tube structure to form a stationary phase coating on that portion of the tube structure. According to the present invention the deactivated stationary-phase sol-gel coating enables separation of analytes while minimizing adsorption of analytes on the sol-gel coated tube structure.

In a preferred form of the capillary column according to the present invention, the deactivated surface-bonded sol-gel coating is applied to the inner wall of the tube structure and has the formula: 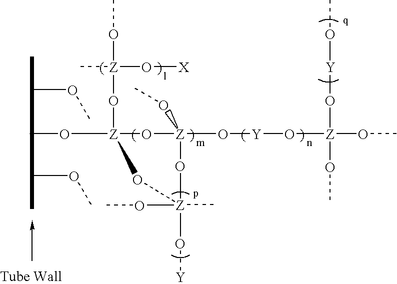
wherein
X=Residual of a deactivation reagent;
Y=Sol-gel reaction residual of a sol-gel-active organic molecule;
Z=Sol-gel precursor-forming element;
l=An integer≧0;
m=An integer≧0;
n=An integer≧0;
p=An integer≧0;
q=An integer≧0; and
l, m, n, p, and q are not simultaneously zero.

Dotted lines indicate the continuation of the chemical structure with X, Y, Z, or Hydrogen (H) in space.

The method of preparing a capillary column according to the principles of the present invention comprise the steps of:

a providing a tube structure;

b. providing a sol-gel solution comprising:
i. a sol-gel precursor,
ii. an organic material with at least one sol-gel active functional group,
iii. a sol-gel catalyst,
iv. a deactivation reagent, and
v. a solvent system;

c. reacting at least a portion of the tube structure with the sol-gel solution under controlled conditions to produce a surface-bonded sol-gel coating on the portion of the tube structure;

d. expelling the sol-gel solution from the portion of the tube structure; and

e. heating the sol-gel coated portion of the tube structure under controlled conditions to cause the deactivation reagent to react with the surface-bonded sol-gel coating to deactivate and to condition the sol-gel coated portion of the tube structure.

Preferably, the step of providing the capillary column includes providing a tube structure with an inner wall, reacting the sol-gel solution with the inner wall of the tube structure to form a surface-bonded sol-gel coating on the inner wall of the tube structure, and then applying gas pressure to the sol-gel solution in the tube structure to force the sol-gel solution out of the tube structure.

Additionally, in the preferred form of the present invention, the tube structure is hydrothermally pretreated before the portion of the tube structure is reacted with the sol-gel solution. This technique generally improves the performance of the sol-gel coated tube structure, and is particularly useful with relatively long tube structures (e.g. longer than about 10 m.).

In this context a principal object of this invention has been to develop a rapid and simple method for simultaneous deactivation, coating, and stationary phase immobilization in GC. To achieve this goal, a sol-gel chemistry-based approach to column preparation is provided that is a viable alternative to conventional GC column technology. The sol-gel column technology eliminates the major drawbacks of conventional column technology through chemical bonding of the stationary phase molecules to an interfacial organic-inorganic polymer layer that evolves on the top of the original capillary surface. This provides a quick and efficient method for the fabrication of high efficiency columns with enhanced thermal stability.

These and other features and objectives of the present invention will become further apparent from the following detailed description and the accompanying drawings.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic cross sectional view of a capillary column constructed according to the principles of the present invention;

FIG. 2 is a schematic end view of a capillary column constructed according to the principles of the present invention;

FIG. 3 is a schematic illustration of apparatus for applying sol-gel coating to a capillary column according to the principles of the present invention;

FIG. 4 is a flow chart of the steps for making a capillary column according to the principles of the present invention;

FIG. 5 is a cross-sectional view of a 250 μm i.d. sol-gel coated PDMS column obtained by scanning electronmicroscopy with a magnification of 240×;

FIG. 6 shows fine surface structures of a sol-gel PDMS coating on the inner walls of a column obtained by scanning electronmicroscopy with a magnification of 1000×;

FIG. 7 is a gas-chromatogram showing gas-chromatographic separation of aldehydes on a sol-gel coated PDMS column;

FIG. 8 is a gas-chromatographic separation of keytones on a sol-gel coated PDMS column;

FIG. 9 shows gas-chromatic separation of dimethylphenol isomers on a sol-gel coated PDMS column;

FIG. 10 shows a gas-chromatographic separation of free fatty acids on a sol-gel coated PDMS column;

FIG. 11 shows the results of capillary gas-chromatographic separation of keytones on a sol-gel coated PDMS stationary phase;

FIG. 12 shows a capillary gas-chromatographic separation of ethanolamines on a sol-gel PDMS coated stationary phase;

FIG. 13 shows a capillary gas-chromatographic separation of C₄-C₃₀ alcohols on a sol-gel PDMS coated stationary phase;

FIG. 14 shows a capillary gas-chromatographic separation of C₁₂-C₃₁ FAMESs on sol-gel PDMS stationary phase;

FIG. 15 shows a capillary gas-chromatographic separation of chlorophenols on sol-gel PDMS stationary phase;

FIG. 16 shows capillary gas-chromatographic separation of C₁₈-C₃₆ n-alkanes on a sol-gel PDMS stationary phase;

FIG. 17 shows a capillary gas-chromatographic separation of chlorophenols on sol-gel PDMS stationary phase;

FIG. 18 shows a capillary gas-chromatographic separation of terphenyl isomers on sol-gel PDMS statioonary phase;

FIG. 19 shows a gas-chromatographic separation of polycyclic aromatic hydrocarbons on a sol-gel coated PDMS column;

FIG. 20 shows a gas-chromatographic separation of a grob mixture on a sol-gel coated ucon column;

FIG. 21 shows a gas-chromatographic separation of a grob mixture on a sol-gel coated PDMS column;

FIG. 22 shows a gas-chromatographic profile of a grob text mixture on a sol-gel PMPS column;

FIG. 23 shows a gas-chromatographic separation of THM on a sol-gel coated PDMS column;

FIG. 24 shows a gas-chromatographic separation of keytones on a sol-gel PMPS column;

FIG. 25 shows a gas-chromatographic separation of halogenated carboxylic acids on a sol-gel PDMS column;

FIG. 26 shows a gas-chromatographic separation of free fatty acids on a sol-gel PDMS column;

FIG. 27 shows a gas-chromatographic separation of aldehydes on a sol-gel coated Carbowax column;

FIG. 28 shows a gas-chromatographic separation of isomers of alcohol on a sol-gel PDMS column;

FIG. 29 shows a gas-chromatographic separation of Cis- and Trans-stilbene;

FIG. 30 shows a gas-chromatographic of xylenes on a sol-gel coated column;

FIG. 31 shows a gas-chromatographic separation of amines and anilines on a sol-gel PMPS column;

FIG. 32 shows a gas-chromatographic separation of glycols on a sol-gel PDMS column;

FIG. 33 shows free amine peak shape various injected amounts on a sol-gel PDMS column;

FIG. 34 shows free acid peak shape at various injected amounts on a sol-gel PDMS column;

FIG. 35 shows gas-chromatographic separation of phenol derivatives on a sol-gel PMPS column;

FIG. 36 shows gas-chromatographic separation of aniline derivatives on a sol-gel Carbowax column;

FIG. 37 shows gas-chromatographic separation of dimethylphenol isomers on a sol-gel Carbowax column;

FIG. 38 shows gas-chromatographic separation of keytones on a sol-gel Carbowax column; and

FIG. 39 shows gas-chromatographic separation of anilines on a sol-gel stationary phase made from trimethoxysilane-terminated PEG.

### DETAILED DESCRIPTION

As described above, the present invention is directed to a capillary column and to a method of making the capillary column. A capillary column constructed according to the present invention is particularly useful in gas chromatography, and is also intended to be useful in forming capillary columns for liquid chromatography, capillary electrochromatography, and supercritical fluid chromatography. Moreover, a capillary column constructed according to the present invention is intended to be useful in providing sample preconcentration, where an analyte sample has a relatively small concentration of a compound of interest, and there is a need for preconcentration of the sample to perform subsequent analysis.

The present invention is described below in connection with the formation of a capillary column intended for use in gas chromatography.

Most generally, the present invention provides a rapid and simple method for simultaneous deactivation, coating, and stationary phase immobilization in GC. To achieve this goal, a sol-gel chemistry-based approach to column preparation is provided that is a viable alternative to conventional GC column technology. The sol-gel column technology eliminates the major drawbacks of conventional column technology through chemical bonding of the stationary phase molecules to an interfacial organic-inorganic polymer layer that evolves on the top of the original capillary surface. This provides a quick and efficient method for the fabrication of high efficiency columns with enhanced thermal stability.

By “evolve” it is meant that a layer is deposited on the tube surface and either polymerics, hardens or otherwise forms and coats to a final state through physical and/or chemical reactions.

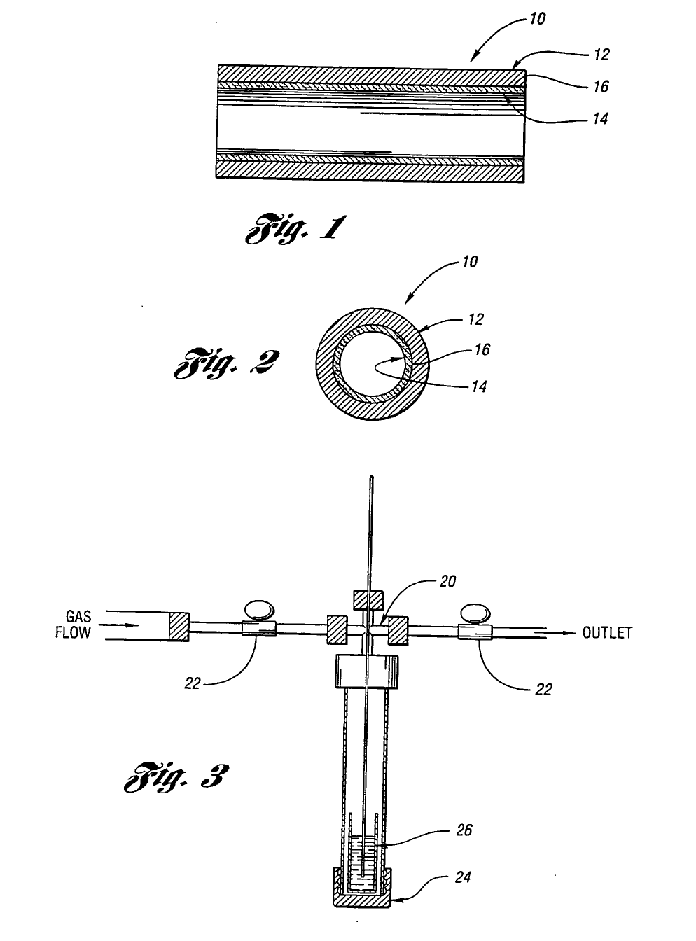

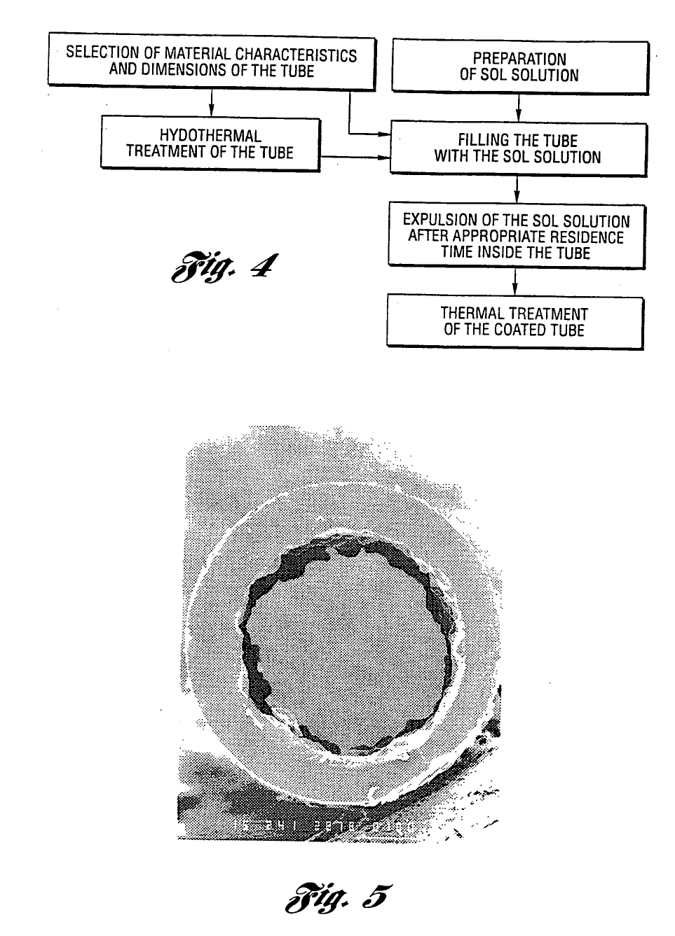

In FIGS. 1 and 2, a capillary column 10 includes a tube structure 12, e.g. made of fused silica, and a deactivated surface-bonded sol-gel coating 14 bonded to the inner wall 16 of the tube structure 12. The deactivated surface-bonded sol-gel coating 14 is applied to the inner wall 16 of the tube structure by means of the apparatus illustrated in FIG. 3 and the method illustrated in FIG. 4.

Fused silica capillary (250 μm i.d.) can be obtained from Polymicro Technologies Inc. (Phoenix, Ariz., USA). HPLC-Grade tetrahydrofuran (THF), methylene chloride, and methanol were purchased from Fisher Scientific (Pittsburgh, Pa., USA). Tetramethoxysilane (TMOS, 99+%), poly(methylhydrosiloxane) (PMHS), and trifluoroacetic acid (containing 5% water), were purchased from Aldrich (Milwaukee, Wis., USA) Hydroxy-terminated poly(dimethylsiloxane) (PDMS), methyl-trimethoxysilane (MTMS) and trimethylmethoxysilane (TMMS) were purchased from United Chemical Technologies, Inc. (Bristol, Pa., USA). Ucon 75-H-90,000 polymer was obtained from Alltech (Deerfield, Ill., USA).

A capillary column according to the present invention basically comprises a tube, and a deactivated surface-bonded sol-gel coating on a portion of the tube to form a solid phase microextraction coating on that portion of the fiber. The solid phase microextraction coating is capable of preconcentrating trace organic compounds in various matrices. The solid phase microextraction-coating has the formula: 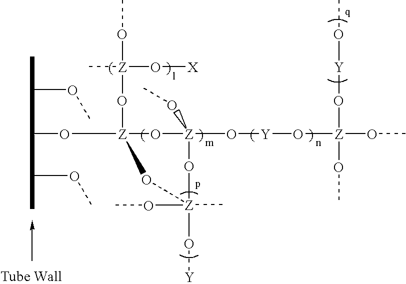
wherein,
X=Residual of a deactivation reagent (e.g., polymethylhydrosiloxane (PMHS), hexamethyldisilazane (HMDS), etc.);
Y=Sol-gel reaction residual of a sol-gel active organic molecule (e.g., molecules with hydroxysilane or alkoxysilane monomers, such as, polydimethylsiloxane (PDMS), polymethylphenylsiloxane (PMPS), polydimethyldiphenylsiloxane (PDMDPS), polyethylene glycol (PEG) and related polymers like Carbowax 20M, polyalkylene glycol such as Ucon, macrocyclic molecules like cyclodextrins, crown ethers, calixarenes, alkyl moieties like octadecyl, octyl, etc.
Z=Sol-gel precursor-forming chemical element (e.g., Si, Al, Ti, Zr, etc.)
l=An integer≧0;
m=An integer≧0;
n=An integer≧0;
p=An integer≧0;
q=An integer≧0; and
l, m, n, p, and q are not simultaneously zero.

Dotted lines indicate the continuation of the chemical structure with X, Y, Z, or Hydrogen (H) in space.

The preparation of the sol-gel coating includes the steps of providing the tube structure, providing a sol-gel solution comprising a sol-gel precursor, an organic material with at least one sol-gel active functional group, a sol-gel catalyst, a deactivation reagent, and a solvent system. The sol-gel solution is then reacted with a portion of the tube (e.g., inner surface) under controlled conditions to produce a surface bonded sol-gel coating on the portion of the tube. The solution is then removed from the tube under pressure of an inert gas and is heated under controlled conditions to cause the deactivation reagent to react with the surface bonded sol-gel coating to deactivate and to condition the sol-gel coated portion of the tube structure. Preferably, the sol-gel precursor includes an alkoxy compound. The organic material includes a monomeric or polymeric material with at least one sol-gel active functional group. The sol-gel catalyst is taken from the group consisting of an acid, a base and a fluoride compound, and the deactivation reagent includes a material reactive to polar functional groups (e.g., hydroxyl groups) bonded to the sol-gel precursor-forming element in the coating or to the tube structure.

Further details of the preferred materials for use in forming the deactivated sol-gel coating are found in Table 1.

Gas chromatographic experiments have been carried out on a Shimadzu Model 14A capillary GC system. A Jeol Model JSM-35 scanning electron microscope has been used for the investigation of coated surfaces. A homemade capillary filling device²² has been used for filling the capillary with the coating sol solution using nitrogen pressure. A Microcentaur Model APO 5760 centrifuge has been used to separate the sol solution from the precipitate. A Fisher Model G-560 Vortex Genie 2 system has been used for thorough mixing of various solution ingredients. A Bamstead Model 04741 Nanopure deionized water system was used to obtain 17.8 MΩ water.

To prepare an open tubular sol-gel column, a fused silica tube 12 of appropriate length and diameter is first rinsed with 5 mL of methylene chloride to clean its inner surface which is then dried by purging with an inert gas. A sol solution is prepared using an alkoxide-based precursor, a hydroxy-terminated stationary phase, a surface derivatizing reagent, and a catalyst dissolved in a suitable solvent system. The sol solution is then centrifuged to remove the precipitates (if any). The tube 12 is filled with the clear sol solution, allowing the latter to stay inside the capillary for a controlled period. As seen in FIG. 3 the capillary filling and purging device comprises a pressurizable air-tight metallic chamber 18 (2.2 cm i.d. and 2.5 cm o.d.). One end of this chamber is fitted with a metallic cross 20. The three free limbs of the cross are threaded at the ends. Each of the two horizontal limbs is connected with an on-off valve 22. One limb is connected to a delivery line from a pressurized helium tank, and serves as the inlet for the capillary filling and purging device. The other horizontal limb serves as the outlet. The bottom end of the chamber 18 is threaded, and equipped with a removable metallic cap 24 with threads that provide an airtight seal.

One end of the capillary passes through a rubber septum in the vertical limb of the cross down forming an airtight seal at the top end of the chamber with the help of a metallic nut. A plastic vial 26 containing the sol-gel solution is placed on the bottom cap of the system so that the end of the capillary is submerged in the sol-gel solution. The cap 24 is then tightened forming an airtight seal at the bottom end of the chamber. The inlet valve is opened to allow helium to enter the chamber and generate a pressure level of 80 psi. The outlet valve is kept closed. Under these conditions, the sol-gel solution enters the capillary and gradually fills it. When the capillary is completely filled with the sol-gel solution, the inlet gas is turned off, and the outlet valve is opened slowly. The outlet end of the capillary is sealed with a piece of rubber septum, and the solution is allowed to stay inside the capillary for a controlled period of time (usually 20-30 minutes). After this, the sol-gel solution is expelled from the capillary under the same pressure by closing the outlet valve first, and the opening the in valve.

The surface-bonded coating 14 formed as a result of sol-gel reactions inside the capillary is then dried by purging it with an inert gas flow. The coated capillary is conditioned at an appropriate temperature determined by the upper temperature limit for the stationary phase. This heating step deactivates the coating as described further below. Prior to first-time operation, the capillary column is rinsed with 1 mL of methylene chloride, and dried with helium purge. Sol-gel open tubular columns have been prepared using four different hydroxy-terminated stationary phases: (a) Ucon-75-H-90,000, (b) polydimethylsiloxane (PDMS), (c) polymethylphenylsiloxane (MPS), and (d) Carbowax (polyethylene glycol). Polyethylene glycol (PEG)-silane columns were also used. The key ingredients of sol solutions used to prepare these columns are listed in Tables 1 and 2.

Preparation of Sol-Gel Ucon Columns

To prepare the sol solution for the Ucon column, 0.187 g of Ucon 75-H-90000 was dissolved in 500 μL of methylene chloride using a Vortex shaker. A 100 μL volume of tetramethoxysilane (TMOS) and 45 μL trifluoroacetic acid (TFA) with 5% added water were then sequentially added with thorough mixing (while 5% added water to the TFA is currently preferred, it is believed that other amounts of added water may be used). The resulting solution was centrifuged. The clear liquid (sol) from the top was transferred to a clean vial. It was further used to fill a previously cleaned and dried fused silica capillary (10 m×250 μm i.d.), using a nitrogen pressure of 100 psi. The solution was expelled from the column under the same nitrogen pressure after allowing it to stay inside the capillary for 30 minutes. The capillary was then purged with nitrogen (100 psi) for 30 minutes, followed by temperature programmed heating from 40° C. to 250° C. at a rate of 1° C. min.⁻¹ using continued purging with helium. The column was held at the final temperature for two hours.

Preparation of Sol-Gel PDMS Columns

The preparation of sol-gel PDMS columns were performed as follows:

Steps Involved in Hydrothermal Treatment

(1) Fill the fused silica capillary with deionized (DI) water under an inert gas pressure (e.g., Helium, 80 psi);

(2) Expel the deionized water from the capillary under the same gas pressure;

(3) Purge the capillary with helium (e.g., under 80 psi helium pressure) for 30 minutes;

(4) Seal both ends of the capillary (e.g., with an oxyacetylene flame);

(5) Heat the capillary by programming the temperature from 40° C. to 250° C. at 4° C./min., and hold the temperature at 250° C. for two hours;

(6) Cool down the capillary to the room temperature;

(7) Open both ends of the using is cutting tool (e.g., an alumina wafer);

(8) Connect one end of the capillary to the injector of a GC system;

(9) Pass helium through the capillary under 100 kPa pressure;

(10) Heat the capillary from 40° C. to 200° C., and hold the temperture at 200° C. for two hours.

Preparation of Sol-Gel Solution

To prepare a 20 m×250 μm i.d. fused silica capillary sol-gel PDMS column*:
*To prepare column of different lengths and dimensions different overall volumes of the solution can be prepared by maintaining the same proportions of the individual components.

(1) Take 0.4 g of hydroxy-terminated PDMS in a clean vial (e.g., polypropylene vial);

(2) Add 400 μL of methylene chloride;

(3) Add 200 μL of methyltrimethoxysilane (MTMOS);

(4) Vortex the mixture for two minutes;

(5) Add 0.085 g of polymethylhydrosiloxane (PMHS);

(6) Vortex the mixture for two minutes;

(7) Add 200 μL of TFA with 0.5% (v/v) of added water;

(8) Vortex the mixture for two minutes;

(9) Centrifuge the solution for three minutes at 13000 RPM (15,682 G);

(10) Decant the clear solution from the top into another clean vial.

Preparation of a Sol-Gel PDMS Column

(1) Select the desired length and dimensions of the fused silica capillary;

(2) Fill the capillary with the sol-gel solution under helium pressure (e.g., 80 psi) using a homemade filling device (FIG. 3);

(3) Reduce the capillary inlet pressure to ambient value (1 atm) by turning off the capillary inlet valve and opening the outlet valve (22, FIG. 3);

(4) Seal the exit end of the capillary (e.g., using a rubber septum);

(5) Allow the sol-gel solution to stay inside the capillary undisturbed for a controlled period of time (e.g., 20 minutes), still keeping the inlet end of the capillary inside the remaining sol solution in the vial;

(6) After the selected residence time (e.g., 20 minutes), remove the sol solution vial, and expel the sol solution from the capillary under the helium pressure of the same magnitude as was used for filling the capillary;

(7) Purge the capillary with helium (e.g., under 80 psi) for one hour;

(8) Heat the capillary column by programming the temperature from 40° C. to 350° C. at 1° C./min., simultaneously purging the capillary column with helium (e.g., under 100 kPa). Continue to heat and purge the column at 350° C. for five hours.

Moreover, in forming both the Ucon and PDMS columns, it is preferable to hydrothermally treat the fused silica tube before applying the sol-gel coating.

The foregoing techniques for forming capillary columns are believed to overcome the following limitations of current gas chromatography capillary column construction: (a) strong dependence of fused silica surface properties on thermal conditions for their industrial manufacture, and on post-drawing storage/handling environments, (b) multi-step technology with difficult-to-reproduce processes and reactions, (c) lengthy and cumbersome individual steps that make the technology excessively time-consuming, and is directly related to the cost of commercially manufactured columns, and (d) lack of stable, chemical bonding between the stationary phase film and the column walls that limits the column thermal stability and lifetime.

The first limitation presents an obstacle to the effective column deactivation through derivatization of silanol groups on the original capillary inner surface. For such an approach to be consistent, the surface derivatization chemistry should be applied to fused silica capillary surfaces with identical or close surface characteristics (e.g., concentration and distribution of surface silanol groups). As was mentioned before, these surface characteristics of fused silica capillaries may greatly vary from batch-to-batch and even within the same batch. Thus, the problem of consistent column deactivation now translates into the problem of preparing capillary surfaces with consistent silanol concentration and distribution. It is believed that conventional deactivation procedures that are based on the derivatization of silanol groups on the original capillary surface are likely to be limited in their effectiveness and consistency. Here, the problems of surface derivatization chemistry combine with the challenges of consistent surface generation and turn into a difficult problem to solve.

In the sol-gel approach of the present invention, the column deactivation problem is viewed from a different perspective. Instead of trying to achieve consistent deactivation through derivatization of capillary walls that often have widely different surface characteristics, the present invention provides for creating a surface-bonded organic-inorganic sol-gel layer on the top of the original capillary surface. In this approach, the original surface serves just as an anchoring substrate for the newly evolving sol-gel top layer before the original surface gets “buried” to disappear in the background. Deactivation takes place as an integral part of the top layer formation during its evolution from solution. The concept of column deactivation finds a wider meaning, extending the silanol derivatization process from the surface into the bulk of the coating. Silanol concentration on the original surface is not likely to have any influence on the deactivation of the top sol-gel coating.

Additionally, according to the present invention, the inherent advantages of sol-gel processes to conduct chemical reactions in solution under extraordinarily mild thermal conditions are employed to achieve surface pretreatment, deactivation, coating, and stationary phase immobilization in a single step. Coating solutions are designed to contain sol-gel-active ingredients that can concurrently undergo liquid-phase reactions inside the capillary and produce a well deactivated, surface-bonded coating. An important aspect of the sol-gel column technology is that the stationary phase itself can serve as a deactivation reagent. Hydroxy-terminated stationary phases are used that can chemically bind with the silanol groups of the growing 3-D network of the sol-gel polymer to form an organic-inorganic composite coating. Deactivation is spontaneously achieved as a consequence of the bonding of stationary phase molecules to the evolving sol-gel network. Such chemical bonding also provides strong immobilization of the stationary phase without requiring any free radical cross-linking reactions. Thus, the sol-gel chemistry-based new approach to column technology effectively combines column coating, deactivation, and immobilization procedures into a single step. Being a single step procedure, the news column technology is fast, cost-effective, and easy to reproduce.

The choice of the solvent system, catalyst, and other sol solution ingredients plays an important role in sol-gel column technology. Tables 1 and 2 list the key ingredients used to prepare columns with two different stationary phases: (a) Ucon—a polyalkylene glycol type polar material, and (b) hydroxy-terminated polydimethylsiloxane (PDMS). For both types of columns, the sol-gel reactions were conducted in an organic-rich solvent system. Methylene chloride was used as the solvent, and trifluoroacetic acid (containing 5% water) served as the catalyst. Neither of these is a typical ingredient for sol-gel processes, since sol-gel reactions are frequently conducted in water-rich solvent systems, and catalyzed either by a strong inorganic acid or a strong base. However, use of the above-mentioned chemicals allowed significant acceleration of the gelation process—a factor which is important for speedy fabrication of columns by sol-gel technique.

Trifluoroacetic acid served multiple purposes: as a catalyst, a solvent, and a source of water. TFA is a strong organic acid with a pKa value of 0.3.²³ Carboxylic acids with pKa values smaller than 4, as was shown by Sharp,²⁴ can provide enhanced gelation speeds that are a few orders of magnitude higher than that provided by an acid with pKa value of greater than 4.0. The key sol-gel reactions involved in the coating procedure are: (1) catalytic hydrolysis of the alkoxide precursor, (II) polycondensation of the hydrolyzed products into a three-dimensional sol-gel network, (III) chemical bonding of hydroxy-terminated PDMS to the evolving sol-gel network, and (V) chemical anchoring of the evolving sol-gel polymer to the inner walls of the capillary. Schematically, these reactions can be represented by the following equations:

Scheme I. Chemical Reactions Involved in Sol-Gel Coating with Hydroxy-Terminated PDMS Stationary Phase.

I. Hydrolysis of the Sol-Gel Precursor:

(R=alkyl or alkoxy groups, and R′=alkyl or hydroxy functionalities) 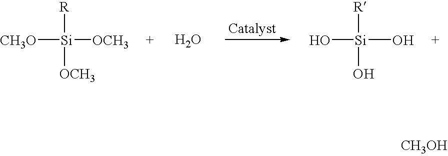
II. Polycondensation of Hydrolyzed Products: 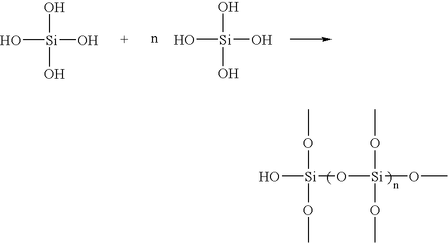
III. Condensation of Hydroxy-Terminated PDMS Molecules to the Evolving Sol-Gel Network: 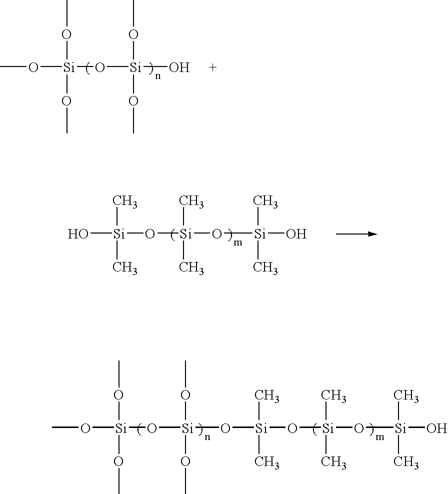
IV. Chemical Anchoring of the Sol-Gel Network to the Capillary Walls to Form a Surface-Bonded Coating:

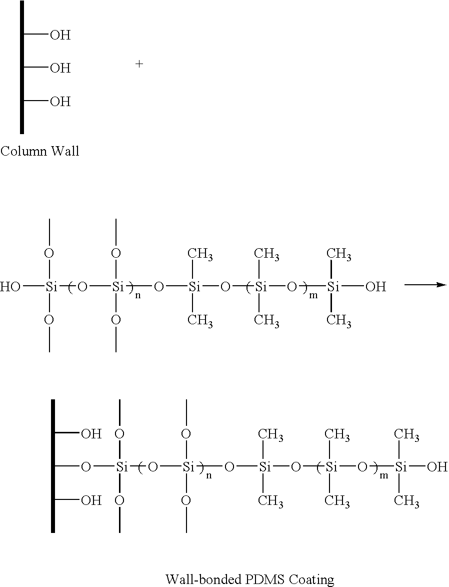

As can be seen from this reaction scheme, the sol-gel procedure represents a dynamic process leading to the evolution of an organic-inorganic stationary phase coating chemically bonded to the original surface. This opens new possibilities to fine-tune the constitutional attributes of the stationary phase (from pure inorganic to pure organic) by controlling the organic/inorganic compositions in the coating sol solution.

Conventionally, tetraalkoxysilanes are used as the sol-gel precursors.²⁵ However, the use of alkyl or aryl derivatives of tetaalkoxysilanes as precursors may provide important advantages. Sol-gel polymers obtained by using these derivative precursors possess more open structures that provide them the flexibility to effectively release the capillary stress generated during drying of the coated surface (gel).²⁶ The absence of such a stress-relieving mechanism (e.g., in gels formed from tetraalkoxysilane precursors) may lead to cracking and shrinking of the coating. This, in turn, may have negative consequences on chromatographic performances of the prepared columns.

FIG. 5 represents a cross-sectional view of a sol-gel coated PDMS column obtained by scanning electron microscopy (SEM) with a magnification of 240. The sol-gel coating is clearly visible as a thin layer on the inner surface of the capillary. FIG. 5 also shows a surface roughening effect due to sol-gel processes on the capillary inner walls. An SEM surface view of the sol-gel coating is presented in FIG. 6. Here, about four times higher magnification (1000) was used. FIG. 6 reveals some fine structural details of this roughened surface.

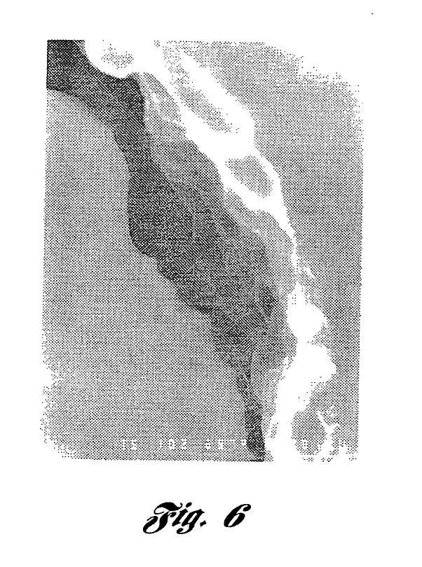

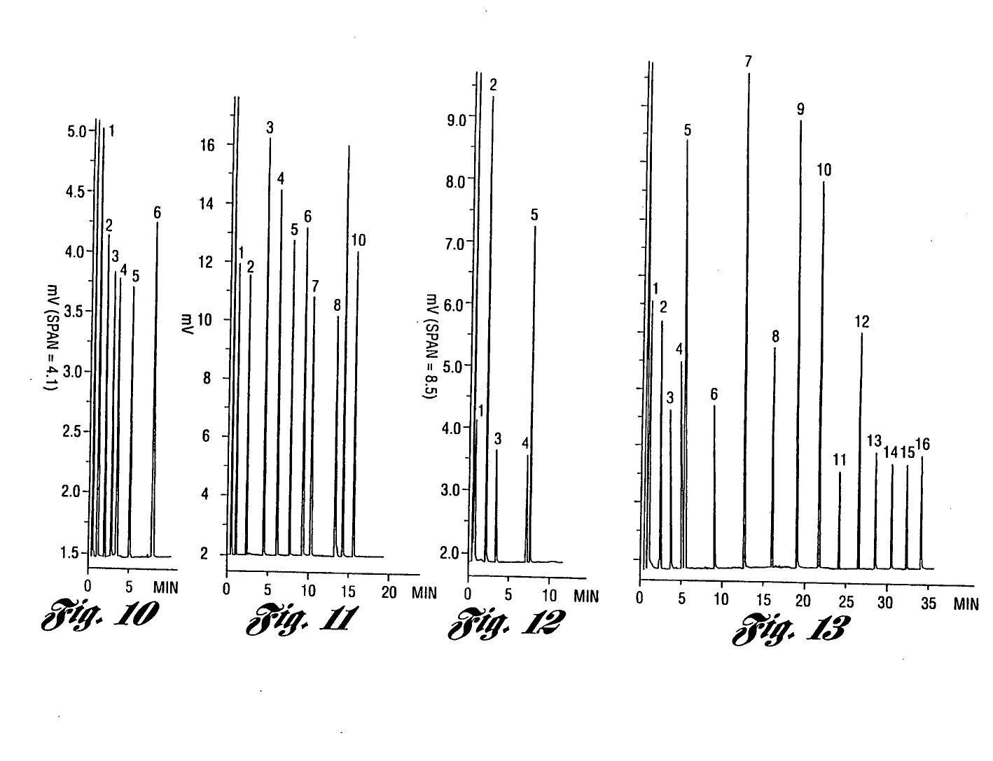

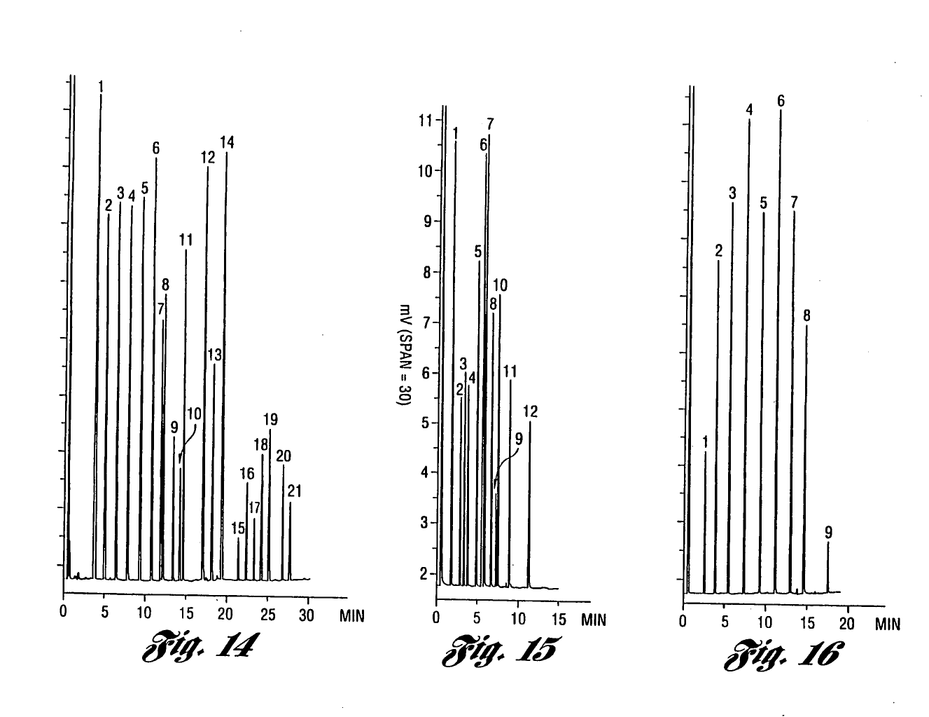

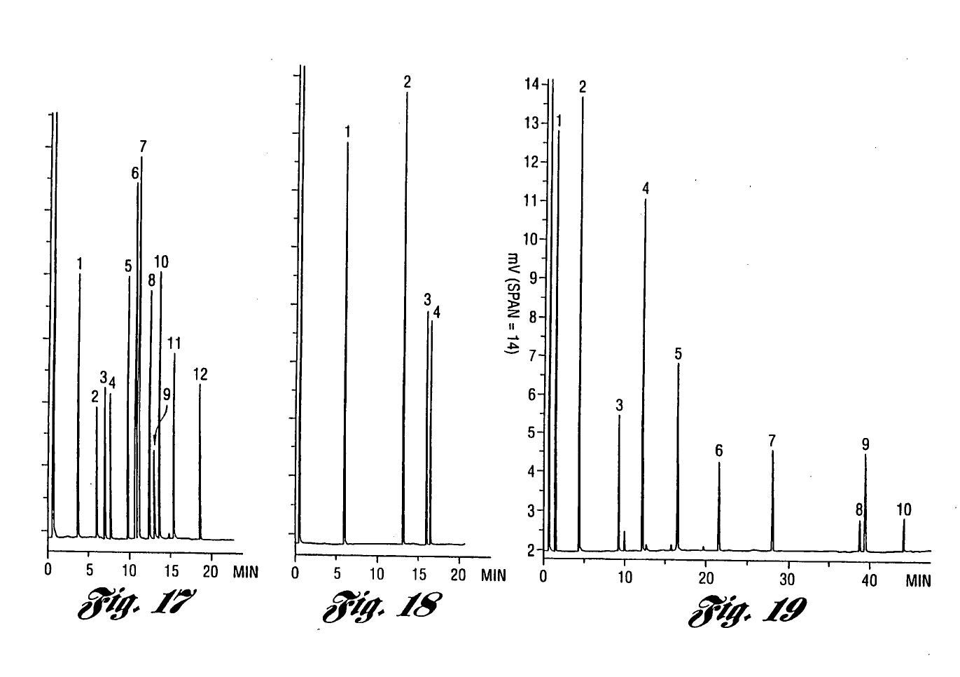

From a column technology point of view, this surface roughening effect is important since it should provide enhanced surface area for the solute/stationary phase interaction during chromatographic separations. It should also provide enhanced sample capacity for the sol-gel coated columns compared with the conventional wall-coated columns. FIGS. 7-19 are gas chromatograms obtained on sol-gel coated capillary columns made according to the principles of the present invention. The appendices describe the experimental conditions under which the columns and chromatograms were produced. As seen from those appendices, the capillary columns provided effective separation of both polar and non-polar analytes. Retention time repeatability data for the components of Grob test mixture is presented in Table 3. The table shows standard deviation in retention time for 13 replicates measurements was less than 0.3% for all the components, except for the two early eluting n-alkanes.

Sol-gel column technology allows to solve these and other difficult separation problems by using conventional stationary phases (e.g. PDMS) in combination with a deactivation reagent (e.g., polymethylhydrosiloxane, PMHS) n the coating sol solution. PMHS are well-known surface deactivation reagents that contain chemically reactive hydrogen atoms for effective derivatization of silanol groups at elevated temperatures.⁴⁶ In contrast to conventional GC column technology, the sol-gel approach does not require any additional steps to deactivate the column using these reagents. It simply requires the addition of appropriate amounts of PMHS to the coating sol solution. After sol-gel coating, the newly created surface layer will contain physically bound molecules of PMHS that will perform the deactivation reaction during the column conditioning step, according to the reaction presented in Scheme

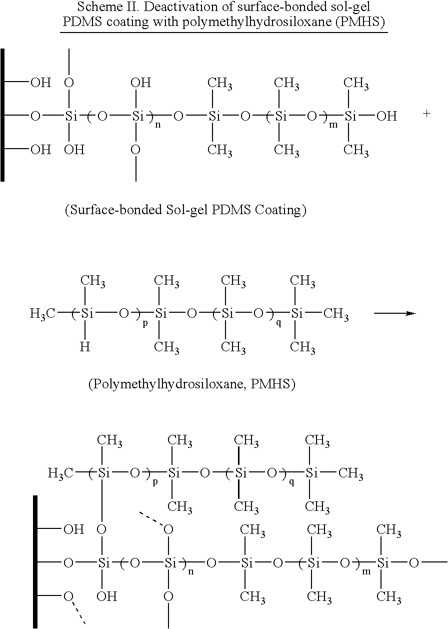

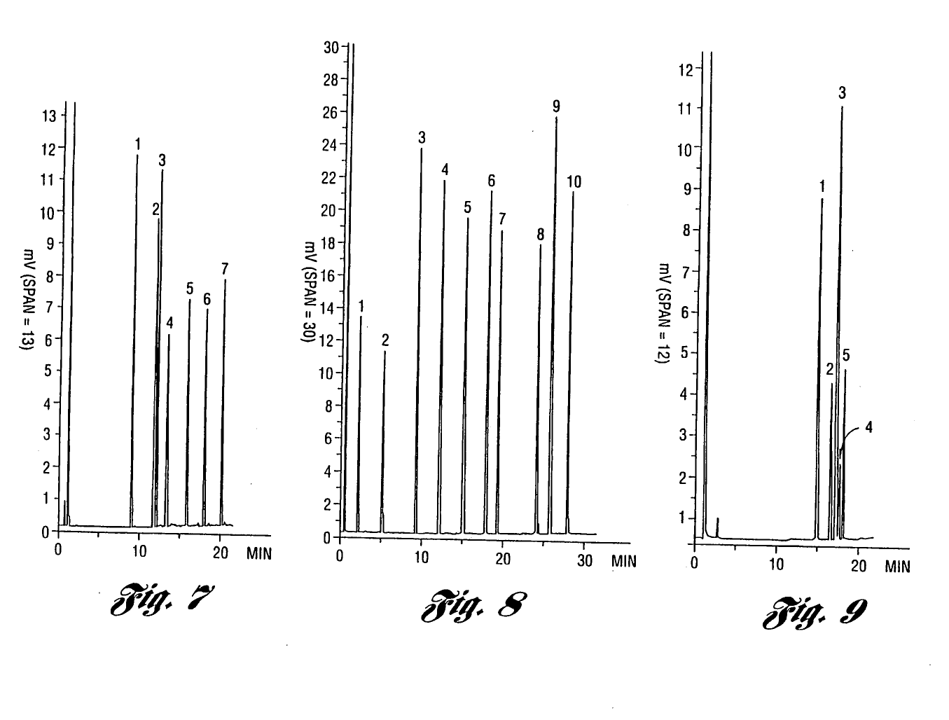

Addition of PMHS to the coating solution provided enhanced deactivation of the column evidenced from the perfect peak shapes of free fatty acids presented in FIG. 10. High efficiency separation of isomeric phenol derivatives (that are also acidic in nature) on a sol-gel PDMS column with PMHS deactivation is illustrated in FIG. 5. Excellent separation of these acidic compounds were achieved under mild thermal conditions using the sol-gel column with organic-inorganic composite coating.

Sol-gel coatings showed significant thermal stability advantage over those conventionally obtained by the static coating technique. It should be pointed out that the sol-gel technology provides high thermal stability not only to thin coatings (d_{f}<1 μm) as are used in gas chromatography, but also to coatings that are a few orders of magnitude thicker. From this perspective, sol-gel technology has much to offer in creating thick, stable coatings (10-100 μm).

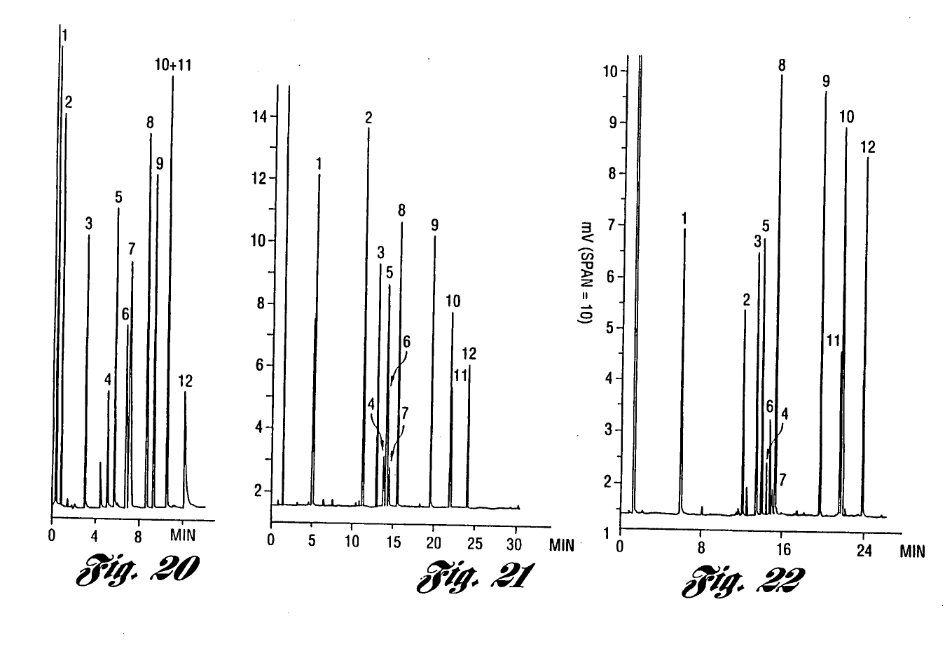

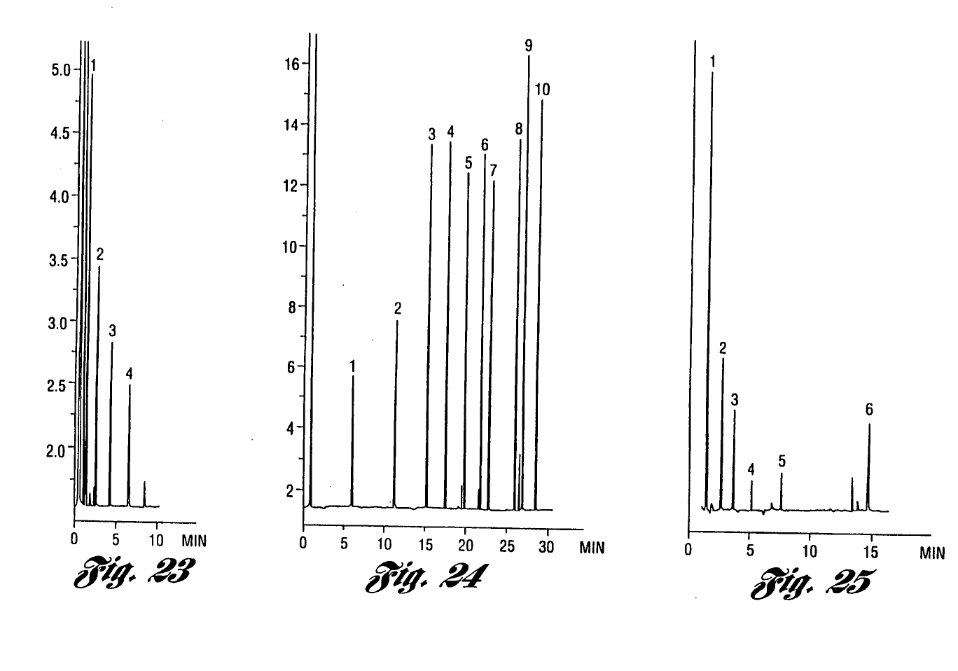

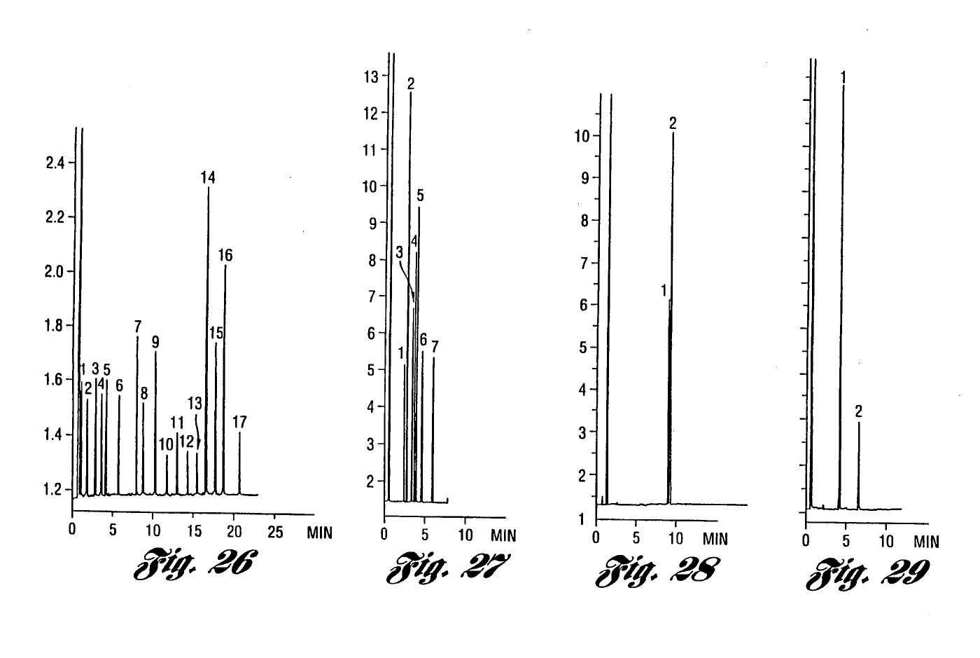

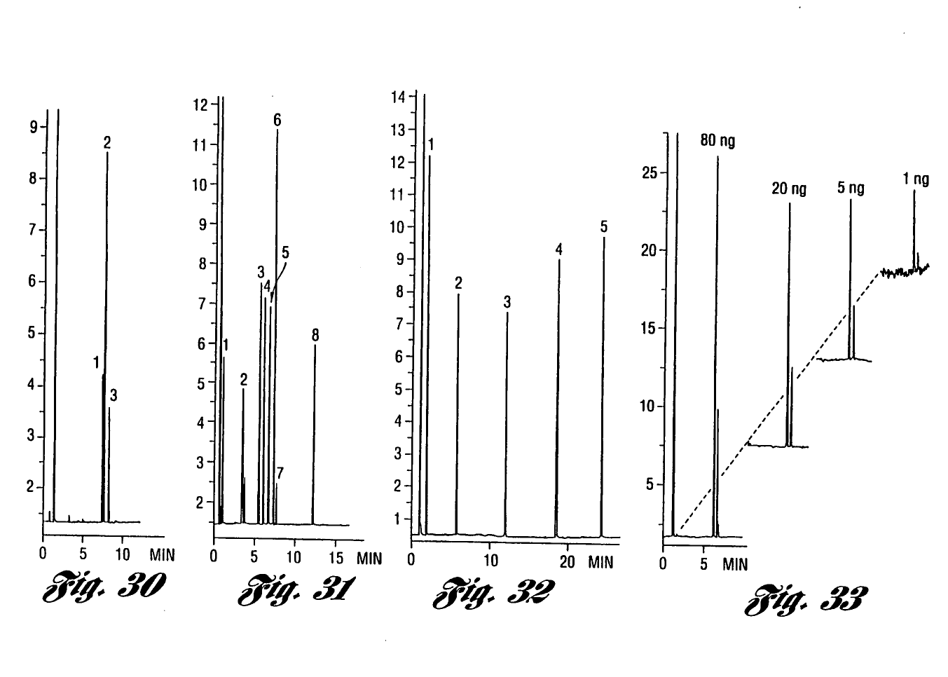

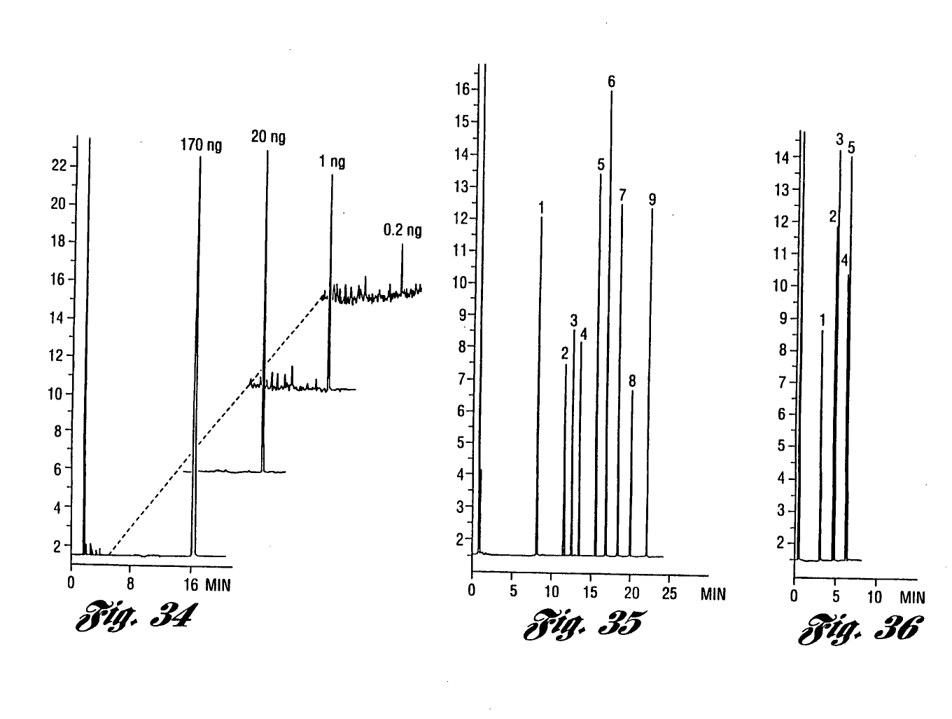

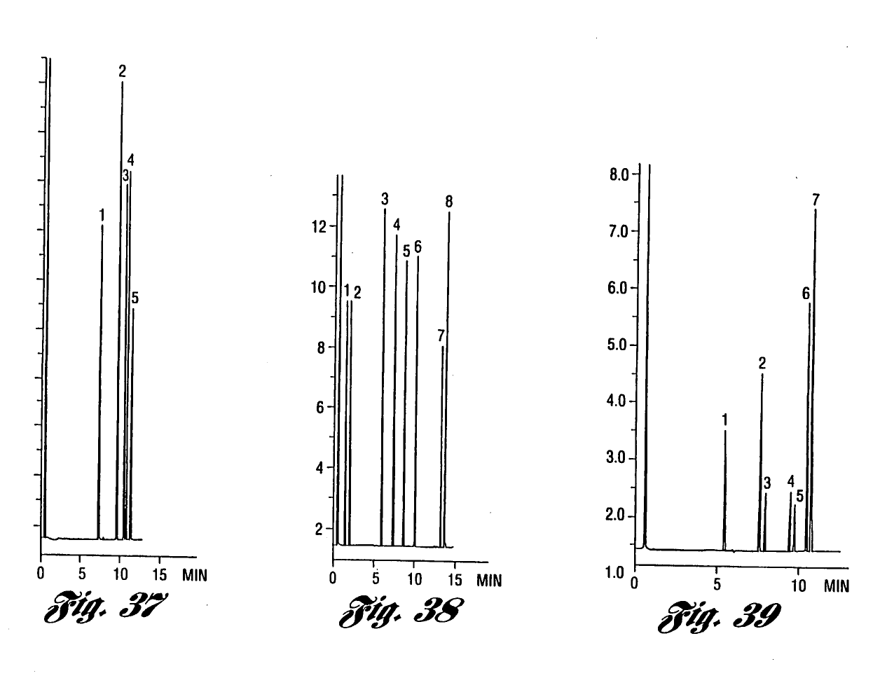

The enhanced thermal stability of sol-gel coatings may be attributed to the formation of strong chemical bonds between the hydroxy-terminated stationary phase and the surface-bonded silica substrate. Unlike conventional approaches to high temperature use of OH-terminated stationary phases,⁴⁹⁻⁵¹ the sol-gel approach does not require the use of glass substrates,⁴⁹ extensive leaching of their surfaces⁵⁰, or high-temperature immobilization⁵¹ of the stationary phase. FIGS. 21-39 demonstrate the ability of the present invention various separations on various columns. The mixtures separated effectively by the present invention range from grob mixtures to a collection of keytones and halogenated carboxylic acids as well as fatty acids. The present invention is also shown, for example in FIG. 28, to be able to separate isomers of alcohol as well as Cis- and Trans-stilbene. The various figures also demonstrate the use of various columns, such as PDMS column, PMPS column, Carbowax column and Ucon.

Table 4 summarizes the free fatty acid retention time repeatability on the sol-gel column made in accordance with the present invention. Soludes tested include a range of various fatty acids, the average retention times being distinct The table shows the conditions that were utilized.

Table 5 shows a comparison of general polarities of conventional and sol-gel GC columns. The distinctions of the various columns are significant.

Table 6 shows the AH of solute-stationary phase interactions in sol-gel columns. The column lists a range of temperatures (K) and the AH in kJ/mole. n-tridecane and n-heptanol were utilized. Sol-gel PDMS, DMDPS, and Ucon were utilized. Table 7 shows the AS of solute stationary phase interactions in sol-gel columns, the same columns being used in Table 7 as were used in Table 6.

Table 8 shows the t^{R} repeatability data for the grob test mixture utilizing three columns in accordance with the present invention The conditions used are shown at the bottom of Table 8.

Table 9 shows the column to column repeatability of separation factor (α) on 7 sol-gel coated PDMS columns. The repeatability is shown to be quite significant between the various columns. The conditions used are disclosed at the bottom of Table 9.

It is believed the potential of sol-gel chemistry in analytical microseparations is significant. It presents a universal approach to creating advanced material systems⁵³ including those based on alumina, titania, and zirconia that have not been adequately evaluated in conventional separation column technology. Thus, the sol-gel chemistry-based column technology has the potential to effectively utilize advanced material properties to fill this gap. Although this prospective approach is just making its first steps in analytical microseparations, it poses a bright prospect for being widely applied in a diverse range of analytical separation techniques.

### CONCLUSION

A sol-gel chemistry-based novel approach to column technology is presented for high resolution capillary GC that provides a speedy way of surface roughening, deactivation, coating, and stationary phase immobilization—all carried out in a single step. Unlike conventional column technology in which these procedures are carried out as individual, time-consuming, steps, the new technology can achieve all these just by filling a capillary with a sol solution of appropriate composition, and allowing it to stay inside the capillary for a controlled period, followed by inert gas purging and conditioning of the capillary. The new technology greatly simplifies the methodology for the preparation of high efficiency GC columns, and offers an opportunity to reduce the column preparation time at least by a factor of ten. Being simple in technical execution, the new technology is very suitable for automation and mass production. Columns prepared by the new technology provide significantly superior thermal stability due to direct chemical bonding of the stationary phase coating to the capillary walls. Enhanced surface area of the columns, as evidenced by SEM results, should provide a sample-capacity advantage to the sol-gel columns. The new methodology provides excellent surface deactivation quality, which is either comparable with or superior to that obtained by conventional techniques. This is supported by examples of high efficiency separations obtained for polar compounds including free fatty acids, amines, alcohols, diols, aldehydes and ketones. The new technology is universal in nature, and is equally applicable to other microseparation and sample preparation techniques including CE, SFC, LC, CEC, and SPME. The sol-gel column technology has the potential to offer a viable alternative to existing methods for column preparation in microseparation techniques.

The foregoing description relates to a technique for forming a capillary column for use in gas chromatography. However, the principles of the present invention can also be used to form capillary columns for use in liquid chromatography, capillary electrochromatography, supercritical fluid chromatography, as well as preconcentrators where a compound of interest is present in very small concentrations in a sample.

### REFERENCES

01. Golay, M. J. E., in Coates, V. J.; Noebels, H. J.; Faberson I. S. (eds.), Gas Chromatography (1957 Lansing Symposium), Academic Press, New York, 1958, pp. 1-013.
02. Altgelt, K. H.; Gouw, T. H., Chromatography in Petroleum Analysis, Marcel Dekker, New York, 1979.
03. Clement, R. E. (ed.), Gas chromatography: Biochemical, Biomedical, and Clinical Applications, Wiley, New York, 1990.
04. Berezkin, V. G., Dmgov, I. S., Gas Chromatography in Air Pollution Analysis, Elsevier, Amsterdam, 1991.
05. Tebbett, I. (Ed.), Gas Chromatography in Forensic Science, E. Horwood, New York, 1991.
06. Poole, C. F.; Poole S. K., in E. Heftman (ed.) Chromatography, 5th Edition, Part A: Fundamentals and Techniques (J. Chromatogr. Libr. Vol. 51A, Amsterdam, 1992), ch. 9.
07. Woolley, C. L.; Kong, R. C.; Richter, B. E.; Leo, M. L., J. High Resolut. Chromatogr. Chromatogr. Commun. 1984, 7, 329-332.
08. Bouche, J.; Verzele, M. J. Gas Chromatogr. 1968, 6, 501-505.
09. Blomberg L. G., J. Microcol. September 1990, 2, 62-67.
10. de Nijs; R. C. M.; Franken, J. J.; Dooper, R. P. M.; Rijks, J. A.; de Ruwe, H. J. J. M.; Schulting, F. L. J. Chromatogr. 1978, 167, 231-242.
11. Schomburg, G.; Husmann, H.; Borwitsky, H., Chromatographia 1979, 12, 651-660.
12. Blomberg, L.; Markides, K. E.; Wannman, T. J. High Resolut. Chromatogr. Chromatogr. Commun. 1980, 3, 527.
13. Lee, M. L.; Kong, R. C.; Woolley, C. L.; Bradshaw, J. S. J. Chromatogr. Sci. 1984, 22, 136-142.
14. Lawrocki, J. Chromatographia 1991, 31, 177-205.
15. Sumpter, S. R.; Woolley, C. L.; Huang, E. C.; Markides, K. E.; Lee, M. L. J. Chromatogr. 1990, 517, 503-519.
16. Abe, I.; Kameyama, K.; Wasa, T.; Chromatographia 27, 631-633 (1989).
17. Ettre, L. S., Hinshaw, J. V. Basic Relationship in Gas Chromatography, Advanstar, Cleveland, USA, 1994, p. 144.
18. Bartle, K. D.; Woolley, C. L.; Markides, K. E.; Lee, M. L.; Hansen, R. S. J. High Resolut Chromatogr./Chromatogr. Commun 1987, 10, 128-136.
19. Wright, B. W.; Peaden, P. A.; Lee M. L.; and Stark T. J., J. Chromatogr. 1982, 248, 17-34.
20. Yakabe, Y.; Sudoh, Y.; Takahata, Y. J. Chromatogr. 1991, 558, 323-327.
21. Blomberg, L.; Wannman, T. J. Chromatogr. 1978, 148, 379-387.
22. Hayes, J. D.; Malik, A. J. Chromatogr. B, 1997, 695, 3-13.
23. Merck Index, 12th Edition, 1996, p. 9812.
24. Sharp, K. G. J. Sol-gel Sci. Technol. 1994, 2, 35-41.
25. Mehrotra, R. C. J. Non-Cryst. Solids 1990, 121, 1-6.
26. Mackenzie, J. D. in Hybrid Organic-Inorganic Composites (ACS Symposium Series, Vol. 585, American Chemical Society, Washington, D.C., 1995), pp. 227-236.
27. Chong, S.-L.; Wang, D.-X.; Hayes, J. D.; Wilhite, B. W.; Malik, A. Anal. Chem., 1997, accepted.
28. Wang, D. X.; Chong, S.-L.; Malik, A., in progress.
29. Ettre, L. S. Chromatographia 1984, 18, 477-488.
30. van Deemter, J. J.; Zuiderweg, F. J.; Klinkenberg, A. Chem. Eng. Sci. 1956, 5, 271-289.
31. Ettre, L. S.; Hinshaw, J. V. Basic Relationship in Gas Chromatography, Advanstar, Cleveland, USA, 1993, p. 127.
32. Berezkin, V. G.; Gavrichev, V. S.; Malik, A. J. Liq. Chromatogr. 1987, 10, 1707-1726.
33. Richter, B. E.; Kuci, J. C.; Park, N. J.; Crowley, S. J.; Bradshaw, J. S.; Lee, M. L. J. High Resolut. Chromatogr./Chromatogr. Commun. 1983, 6, 371-373.
34. Grob, K.; Grob, G.; Blum, W.; Walther, W. J. Chromatogr. 1982, 244, 197-204.
35. Lee, M. L.; Yang, F. J.; Bartle, K. D. Open Tubular Column Gas Chromatography: Theory and Practice, Wiley, New York, 1984.
36. Alitech Chromatography Catalog, 1997, p. 172.
37. Grob, K. Jr.; Grob, G.; Grob, K.; 1978, 156, 1-20.
38. Woolley, C. L.; Markides, K. E.; Lee, M. L.; Bartle, K. D. J. High Resolut. Chromatogr./Chromatogr. Commun. 1986, 9, 506-514.
39. Ballesteros, E.; Cardenas, S.; Gallego, M.; Valcarcel, M. Anal. Chem. 1994, 66, 628-634.
40. Brown, P. R.; Beebe, J. M.; Turcotte, J. Crit. Rev. Anal. Chem. 1989, 21, 193-208.
41. de Jong, C.; Badings, H. J. High Resolut. Chromatogr. 1990, 13, 94-98.
42. Blau, K.; King, G., Eds. Handbook of Derivatives for Chromatography, 2nd ed.; Heyden: London, 1993.
43. Vicanova, J.; Tvrzicka, E.; Stulik, K. J. Chromatogr. B 1994, 656, 45-50.
44. Rotzsche, R. Stationary Phases in Gas Chromatography, Elsevier, Amsterdam, 1991, p. 256.
45. Wang, D.-X; Malik, A.; Manuscript in preparation.
46. Woolley, C. L.; Markides, K. E.; Lee, M. L. J. Chromatogr. 1986, 367, 9-22.
47. Wang, D. X.; Malik, A. Manuscript in preparation.
48. Chong, S.-L.; Malik, A. Manuscript in preparation.
49. Blum, W. J. High Resolut. Chromatogr./Chromatogr. Commun. 1986, 9, 350-355.
50. Aichholz, W. J. High Resolut. Chromatogr. 1990, 13, 71-73.
51. Welxch, T.; Teichmann, U., J. High Resolut. Chromatogr., 1991, 14, 153-159.
52. Hayes, J. D.; Malik, A. HPCE '97—Final Program (Jan. 26-30, 1997, Anaheim, Calif., USA), pp. 80-81.
53. Brinker, C. J.; Scherer G. W. Sol-gel Science: The Physics and Chemistry of Sol-gel Processing, Academic Press, San Diego, USA, 1990.
54. Guo, Y; Colon, L. A. Anal. Chem. 1995, 67, 2511-16.
55. Malik, A.; Hayes, J. D.; Wang, D. X.; Chong, S.-L.; Corbett, G. S.; Cramer, J. W.; Proc. 19th International Symposium on Capillary Chromatography and Electrophoresis, Wintergreen, Va., USA, May 18-22, 1997, pp. 54-55.
56. Engelhardt, H.; Cunat-Walter, M. A. J. Chromatogr. 1995, 716, 27-33.
57. Wang, D.; Malik, A. Proc. 18th Intl. Symp. Cap. Chromatogr. (May 20-24, 1996, Riva del Garda, Italy), P. Sandra & G. Devos (eds.), Huthig Publishers: Germany, 1996, pp. 505-513.
58. Guo, Y.; Imahori, G. A.; Colon, L. A.; J. Chromatogr. A. 1996, 744, 17-29.

59. Doesey, J. G.; Lister, A. S.; Wright, P. B.; Wendelken, S. C.; Chester, T. L. Proc. 19th International Symposium on Capillary Chromatography and Electrophoresis, Wintergreen, Va., USA, May 18-22, 1997, pp. 62-63.

TABLE 1

| | Name of the Chemicals | Source | Catalog # |
|---|---|---|---|
| Precursor: | 1. Methyltrimethoxysilane | Aldrich Chemical Company, Inc. | 24,617-4 |
| | 2. Tetramethyl orthosilicate | Aldrich Chemical Company, Inc. | 34,143-6 |
| Stationary phase: | 1. Polydimethylsiloxane, | United chemical technologies, Inc. | P S 343.5 |
| | silanol terminated 2,000 CS | | |
| | 2. Ucon 75-H-90,000 | Altech Associates, Inc. | 5387 |
| | 3. Polymethylphenylsiloxane (PMPS) | United Chemical Technologies, Inc. | PS084 and PS088 |
| | 4. Methoxy-PEG-Silane | Fluka Chemical Co. | 92193 |
| | 5. PEG-(Silane)₂ | Shearwater Polymers, Inc. | SIL-3400 |
| | 6. Carbowax 20M | Alltech Associate, Inc. | 5069 |
| Deactivating | Poly(methylhydrosiloxane) | Aldrich Chemical Company, Inc. | 17,620-6 |
| reagent: | | | |
| Catalyst: | 1. Trifluoroacetic acid | Sigma Chemical Co. | T 6508 |
| | 2. Ethanolamine | Aldrich Chemical Company, Inc. | 41,100-0 |
| Solvent: | 1. Methylene chloride | Fisher Scientific | D 143-1 |
| | 2. Tetrahydrfuran | Fisher Scientific | T 425-1 |

Table 2
Names and chemical structures of sol-gel coating solution ingredients

| Ingredients | Name | Structure |
|---|---|---|
| Precursor | Methyltrimethoxysilane | 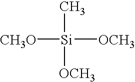 |
| Precursor | Tetramethoxysilane | 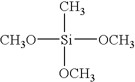 |
| Polymer | Ucon 75-H-90,000 | 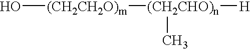 |
| Polymer | Polydimethylsiloxane, Silanol Terminated | 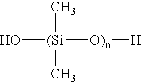 |
| Catalyst | Trifluoroacetic Acid/Water 95%: 5% (V/V) | CF₃COOH |
| Solvent | Methylene Chloride | CH₂Cl₂ |
| Deactivation reagent | Polymethylhydrosiloxane | 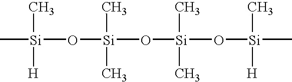 |
| Polymer | Hydroxy-terminated Polymethylphenylsiloxane (PMPS) | 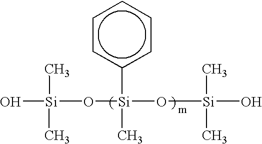 |
| Polymer | Carbowax 20M | 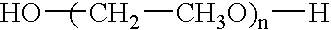 |
| Precursor | Methoxy-PEG-Silane | 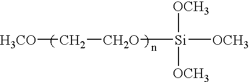 |
| Precursor | PEG-(Silane)₂ | 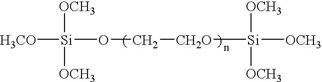 |

TABLE 3
Retention time repeatability data for the components or Grob
test mixture obtained on a sol-gel coated Ucon column

| | Average | | Relative |
|---|---|---|---|
| | Retention | Standard | Standard |
| Solutes | Time (min) | Deviation | Deviation |
| n-Decane | 0.56 | 4.08 × 10⁻³ | 0.73 |
| n-Undecane | 0.99 | 5.55 × 10⁻³ | 0.56 |
| 1-Nonanal | 3.38 | 8.62 × 10⁻³ | 0.26 |
| 2,3-Butanediol | 5.37 | 5.99 × 10⁻³ | 0.11 |
| 1-Octanol | 6.04 | 3.76 × 10⁻³ | 0.06 |
| Methyl Decanoate | 7.13 | 8.01 × 10⁻³ | 0.11 |
| Dicyclohexylamine | 7.48 | 5.55 × 10⁻³ | 0.07 |
| Methyl Undecanoate | 9.10 | 8.77 × 10⁻³ | 0.10 |
| 2,6-dimethylaniline | 9.77 | 3.76 × 10⁻³ | 0.04 |
| Methyl Dodecanoate and 2,6- | 11.03 | 1.01 × 10⁻² | 0.09 |
| Dimethylphenol | | | |
| 2-Ethyl Hexanoic Acid | 12.78 | 3.56 × 10⁻² | 0.28 |

TABLE 4
Free Fatty Acid Retention Time
Repeatability on a Sol-gel Column

| | Average retention | SD | |
|---|---|---|---|
| Solutes | Time(min) | (min) | RSD(%) |
| acetic acid | 0.98 | 2.51 × 10⁻³ | 0.26 |
| propionic acid | 1.71 | 5.62 × 10⁻³ | 0.33 |
| butyric acid | 2.78 | 8.49 × 10⁻³ | 0.31 |
| isovaleric acid | 3.56 | 6.44 × 10⁻³ | 0.18 |
| valeric acid | 4.18 | 9.21 × 10⁻³ | 0.22 |
| hexanoic acid | 5.69 | 6.86 × 10⁻³ | 0.12 |
| 2-ethylhexanoic acid | 8.01 | 6.85 × 10⁻³ | 0.09 |
| octanoic acid | 8.76 | 4.69 × 10⁻³ | 0.05 |
| nonanoic acid | 10.24 | 4.35 × 10⁻³ | 0.04 |
| decanoic acid | 11.64 | 4.43 × 10⁻³ | 0.04 |
| undecanoic acid | 12.99 | 2.79 × 10⁻³ | 0.02 |
| lauric acid | 14.27 | 2.70 × 10⁻³ | 0.02 |
| tridecanoic acid | 15.49 | 2.79 × 10⁻³ | 0.02 |
| myristic acid | 16.66 | 4.55 × 10⁻³ | 0.03 |
| pentadecanoic acid | 17.76 | 4.01 × 10⁻³ | 0.02 |
| palmitic acid | 18.82 | 2.84 × 10⁻³ | 0.02 |
| stearic acid | 20.81 | 4.26 × 10⁻³ | 0.02 |

Conditions: column, 10 m × 250 μm fused silica capillary; stationary phase, hydroxy-terminated PDMS; carrier gas, helium; injection, split (100:1, 330° C.); detector, FID, 350° C.; column temperature, 40° C. at 6° C./min.

TABLE 5
Comparison of General Polarities (P_{gen.}) of Conventional and
Sol-gel GC Columns

| Stationary Phase | Conventional | Sol-Gel |
|---|---|---|
| PDMS | 229 (OV-101) | 264 |
| PMPS: | | |
| OV-7 (20% Phenyl) | 592* | 452 (15% phenyl) |
| DC556 (10% Phenyl) | 274* | |
| SE-52 (5% Phenyl) | 267* | |
| UCON 75-H-9000 | 1152* | 1927 |

*Ref.: H. Rotzsche, Stationary Phases in Gas Chromatography, Elsevier, Amsterdam, 1990, pp. 221, 257.

TABLE 6
ΔH of Solute-Stationary Phase Interactions in
Sol-Gel Columns

| | ΔH (k J/mole) | | | | | |
|---|---|---|---|---|---|---|
| Tem- | n-tridecane | | | n-heptanol | | |
| perature | Sol-gel | Sol-gel | Sol-gel | Sol-gel | Sol-gel | Sol-gel |
| (K) | PDMS | DMDPS | Ucon | PDMS | DMDPS | Ucon |
| 333 | 59.541 | — | 50.994 | 45.012 | — | 56.312 |
| 343 | 58.285 | — | 50.937 | 43.085 | 46.809 | 54.258 |
| 353 | 56.037 | — | 48.473 | 42.720 | 44.851 | 52.521 |
| 363 | 54.709 | 57.185 | 47.730 | 41.876 | 44.240 | 51.557 |
| 373 | 53.567 | 55.823 | 45.134 | 39.789 | 42.164 | 50.003 |
| 383 | 51.934 | 54.437 | 45.051 | 38.293 | 40.921 | 47.303 |
| 393 | 51.222 | 53.461 | 41.083 | 37.001 | 40.425 | 45.428 |
| 403 | — | 51.753 | — | — | 38.469 | — |

TABLE 7
ΔS of Solute-Stationary Phase Interactions in
Sol-Gel Columns

| | ΔS (J/mole · K) | | | | | |
|---|---|---|---|---|---|---|
| Tem- | n-tridecane | | | n-heptanol | | |
| perature | Sol-gel | Sol-gel | Sol-gel | Sol-gel | Sol-gel | Sol-gel |
| (K) | PDMS | DMDPS | Ucon | PDMS | DMDPS | Ucon |
| 333 | 85.451 | — | 89.184 | 64.774 | — | 99.884 |
| 343 | 81.793 | — | 89.017 | 59.154 | 62.758 | 93.898 |
| 353 | 75.425 | — | 82.043 | 58.123 | 57.211 | 88.976 |
| 363 | 71.766 | 73.504 | 79.989 | 55.803 | 55.528 | 86.319 |
| 373 | 68.699 | 69.854 | 73.030 | 50.204 | 49.963 | 82.153 |
| 383 | 64.442 | 66.238 | 72.814 | 46.299 | 46.717 | 75.100 |
| 393 | 62.629 | 63.752 | 62.721 | 43.011 | 45.453 | 70.336 |

TABLE 9
Column-to-Column Repeatability of Separation Factor
(α) on 7 So-gel Coated PDMS Columns

| Solute Pair | T (° C.) | Col. # 1 | Col. # 2 | Col. #3 | Col. #4 | Col. # 5 | Col. #6 | Col. #7 | RSD (%) |
|---|---|---|---|---|---|---|---|---|---|
| Cis/trans stilbene | 180 | 1.991 | 1.996 | 1.992 | 2.001 | 1.998 | 2.000 | 1.997 | 0.19 |
| Phenanthrene/ | 200 | 1.036 | 1.036 | 1.036 | 1.035 | 1.037 | 1.037 | 1.037 | 0.07 |
| Anthracene | | | | | | | | | |
| 2,4-DMP/2,6-DMP | 150 | 1.178 | 1.179 | 1.178 | 1.177 | 1.178 | 1.178 | 1.177 | 0.06 |
| m- and p-terphenyl | 250 | 1.123 | 1.123 | 1.122 | 1.121 | 1.123 | 1.123 | 1.122 | 0.07 |
| p-xylene/m-xylene | 70 | 1.062 | 1.064 | 1.063 | 1.068 | 1.067 | 1.067 | 1.067 | 0.22 |
| 2- and 4- | 70 | 1.077 | 1.077 | 1.076 | 1.078 | 1.075 | 1.078 | 1.076 | 0.10 |
| methylcyclohexanol | | | | | | | | | |
| 3- and 4-ethylaniline | 80 | 1.034 | 1.034 | 1.034 | 1.035 | 1.034 | 1.034 | 1.036 | 0.08 |
| Methylundecanoate/ | 150 | 1.057 | 1.055 | 1.055 | 1.063 | 1.063 | 1.064 | 1.063 | 0.39 |
| dicyclohexylamine | | | | | | | | | |

Condition: column, 20 m × 250 μm fused silica capilary; stationary phase - Sol-gel PDMS; injector, split(100:1, 250° C.); Detector, FID 350° C.

TABLE 8
t_{R} Repeatability Data for Grob Test Mixture

| | RSD(%) (n = 10) | | |
|---|---|---|---|
| Solutes | PDMS | UCON* | PMPS |
| 2,3-butanediol | 0.14 | 0.11 | 0.12 |
| n-decane | 0.11 | 0.73 | 0.09 |
| 1-octanol | 0.09 | 0.06 | 0.06 |
| 2,6-dimethylphenol | 0.09 | 0.26 | 0.02 |
| 1-nonanal | 0.07 | 0.09 | 0.02 |
| undecane | 0.09 | 0.56 | 0.04 |
| 2-ethylhexanoic acid | 0.22 | 0.28 | 0.26 |
| 2,6-dimethylaniline | 0.06 | 0.04 | 0.02 |
| methyl decanoate | 0.06 | 0.11 | 0.06 |
| dicyclohexylamine | 0.05 | 0.07 | 0.05 |
| methyl undecanoate | 0.05 | 0.10 | 0.05 |
| methyl dodecanoate | 0.04 | 0.09 | 0.04 |

Conditions: columns - 20 m × 250 μm fused silica capillary; stationary phases - sol-gel PDMS, sol-gel UCON, and Sol-gel PMPS, carrier gas, helium; injection, split (100:1, 250° C); detector, FID, 350° C.; column temperature, 40° C. at 6° C./min.

We claim:

1. A capillary gas chromatographic column comprising:
a tube structure with an inner surface containing at least one sol-gel-active functional group on the inner surface; and
a deactivated, surface bonded sol-gel coating further comprising an organic-inorganic composite on a portion of the tube structure to form a stationary phase coating on that portion of the tube structure, said deactivated stationary phase sol-gel coating enabling separation of analytes while minimizing adsorption of analytes on the sol-gel coated tube structure; wherein said deactivated stationary phase sol-gel coating is deactivated at the inner surface of said tube structure and within the coating; wherein said sol-gel coating is bonded to the inner surface via an oxygen element; and wherein said sol-gel coating is immobilized without a free radical cross-linking reaction.

2. The capillary gas chromatographic column according to claim 1, wherein said deactivated surface bonded sol-gel-coating on the portion of the tube structure has the formula: 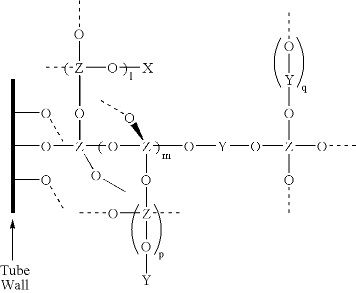
wherein,
X=Residual of a deactivation agent;
Y=Sol-gel reaction residual of a Sol-gel active organic molecule;
Z=Sol-gel precursor-forming element;
l=an integer≧0;
m=an integer≧0;
n=an integer≧0;
p=an integer≧0;
q=an integer≧0; and
l, m, n, p and q are not simultaneously zero.

3. The capillary gas chromatographic column according to claim 2, wherein the residual of the deactivation reagent is selected from the group consisting of polymethylhydrosiloxane and hexamethyldisilazane.

4. The capillary gas chromatographic column according to claim 2, wherein said sol-gel reaction residue is selected from the group consisting of molecules having hydroxysilane functional groups, molecules having alkoxysilane functional groups, molecules having at least one hydroxysilane group and at least one alkoxysilane group, polydimethylsiloxane (PDMS), polymethylphenylsiloxane (PMPS), polydimethyldiphenylsiloxane (PDMDPS), polyethylene glycol (PEG), polalkylene glycol, and alkyl moieties.

5. The capillary gas chromatographic column according to claim 2, wherein said sol-gel precursor forming element is selected from the group consisting of Si, Al, Ti, and Zr.

6. A method of preparing a capillary gas chromatographic column comprising the steps of:
providing a tube structure having sol-gel-active functional groups;
providing a sol-gel solution comprising:
a sol-gel precursor;
an organic ligand with at least one sol-gel active functional group;
a sol-gel catalyst;
a deactivation reagent; and
a solvent system including water;
reacting at least a portion of the tube structure with the sol-gel solution under controlled conditions to produce a surface-bonded sol-gel coating on the portion of the tube structure, wherein said sol-gel coating is surface-bonded via an oxygen element, and wherein said reacting step excludes a free radical cross-linking reaction;
expelling the sol-gel solution from the portion of the tube structure; and
heating the coated portion of the tube structure under controlled conditions to cause the deactivation reagent to react with the surface-bonded sol-gel coating to deactivate and to condition the sol-gel coated portion of the tube structure.

7. The method according to claim 6, wherein the step of providing the tube structure comprises providing a tube structure with an inner wall, reacting the sol-gel solution with the inner wall of the tube structure for a period of less than 1 hour to form a surface bonded sol-gel coating on the inner wall of the tube structure, and then applying gas pressure to the sol-gel solution in the tube structure to expel the sol-gel solution from the tube structure.

8. The method according to claim 7, wherein the sol-gel precursor comprises an alkoxy compound, the organic material comprises monomeric or polymeric material with at least one sol-gel active functional group, the sol-gel catalyst is selected from the group consisting of an acid, a base and fluoride compound, and the deactivation reagent comprises a material reactive to hydroxyl groups bonded to the sol-gel precursor forming element or to the tube wall surface.

9. A method of preparing a capillary gas chromatographic column comprising the steps of:
providing a capillary gas chromatographic column comprising at least one sol-gel active functional group containing tube structure; and
creating, coating, immobilizing and deactivating a stationary phase comprising an organic-inorganic composite coating on the tube structure, wherein said creating, coating, immobilizing, and deactivating occurs in the same step, and wherein said creating, coating, immobilizing, and deactivating excludes a free radical cross-linking reaction.

10. The method according to claim 9, wherein the immobilization of the stationary phase comprises forming chemical bonds between the stationary phase and the sol-gel active functional group on the capillary wall.

11. The capillary gas chromatographic column according to claim 4, wherein the alkyl moiety comprises octadecyl moiety.

12. The capillary gas chromatographic column according to claim 4 wherein the alkyl moiety comprises an octyl moiety.

13. The capillary gas chromatographic column according to claim 1, wherein the stationary phase coating comprises a sol-gel polymer layer having organic and inorganic components.

14. The capillary gas chromatographic column according to claim 1, wherein the sol-gel-active functional group is derivatized.

15. The method according to claim 9, wherein the step of creating a stationary phase comprises chemically reacting sol-gel active components of an aqueous solution.

16. The method according to claim 9, wherein the tube structure is contacted with the stationary phase, and the stationary phase comprises an organic and inorganic interfacial polymer layer.

17. The method according to claim 9, wherein the stationary phase comprises a sol-gel polymer layer having organic and inorganic components.

18. The method according to claim 9, wherein said deactivating the stationary phase comprises reacting the silanol group with sol-gel active components of a sol solution at substantially the same time as creating the stationary phase coating.

19. The method according to claim 9, wherein deactivating the stationary phase comprises reacting the silanol groups while the tube structure is subjected to heat treatment.

20. The method according to claim 9, wherein said creating, coating, immobilizing, and deactivating occurs in an aqueous solution.
